(19) United States
(12) Patent Application Publication
(10) Pub. No.: US 2002/0119791 A1
(43) Pub. Date: Aug. 29, 2002

(54) Method and system for locating target destinations within short ranges

(76) Inventor: Zhongze Bai, Gardena, CA (US)

Correspondence Address: Philip K. Yu, Registered Patent Attorney, 20955 Pathfinder Road, Ste. 160, Diamond Bar, CA, 91765, US

(21) Appl. No.: 10/083,895

(22) Filed: Feb. 27, 2002

Related U.S. Application Data
(60) Provisional application No. 60/272,099, filed on Feb. 28, 2001.

(51) Int. Cl. H04Q 7/20

(52) U.S. Cl. 455/456; 455/457

(57) ABSTRACT

A method and system for a local direction finding network is disclosed. The system uses a tracking unit to locate a target location by transmitting signals from the target location to the tracking unit. The tracking unit then verifies the source of the transmission. If matched with the target code entered, the received transmission is used by the tracking unit to determine the bearing and strength, hence navigation information, of the source of the transmission. The tracking unit can then move closer and closer toward the target location based on the navigation information. Many target locations may be represented by a single transmitter, which will direct the tracking unit to the desired target location, based on the known locations of the transmitter and the target location. Additionally, a networked group of transmitters can be implemented, which, through successive handing off, will direct the tracking unit from one cell to the cell where the target location is located.

### RELATED APPLICATION

The present application claims priority from provisional applications, Application No. 60/272,099, entitled “Third Eye”, filed on Feb. 28, 2001. The prior applications are hereby incorporated into this application by reference as if fully set forth herein.

### FIELD OF THE INVENTION

The present invention relates to radio frequency (‘RF”) and wireless communication systems, and more particularly relates to RF and wireless communication systems that help users locate target destinations or target locations in short ranges.

### ART BACKGROUND

RF and wireless communication technology has become an integral and important part of our modern lives. From the earlier days of walkie-talkies and Citizens Band radios, RF technology has made tremendous progress in areas such as digital cordless telephony, cellular and mobile telephony, wireless paging, to global positioning systems (“GPS”), all of which are implemented to help users stay in touch and stay informed in almost all aspects of the daily routine.

One area of our everyday life, however, has been under-served despite progresses made in modern RF technology. That is, while a person is driving or walking around, looking for a destination, such as a restaurant, an office, or a bookstore, she cannot “see” the desired destination, unless she happens to observe any signage or billboard installed by the establishments. The only guide the driver has is perhaps a street and a number, which require the driver to constantly check the street sign and door number. This kind of “short-range” destination location still depends on a person's physical observation to pin-point the destination. Looking up a map seems incredibly dangerous when one is trying to drive the car at the same time.

It should be pointed out that this situation of “short-range” or “final approach” destination location is different from scenarios where a person looks up the location in the map, or follows the driving instructions downloaded from navigation web sites on the Internet. These means of locating a destination can get the person close to within a few blocks from the destination within a city. However, the person then still has to look for street signs, door numbers, building numbers, check the map or instructions, or all of the above, for the final approach.

While there are GPS-based navigation tools available in both hand-held or in-car models, these tools are not exactly the “final solution” in terms of providing adequate and easy guidance for the final approach in the “short range” setting. In a spread-out rural neighborhood, it may be easier to follow the directions issued by the navigational tool or maps. However, in an urban area, such as downtown Los Angeles or New York, it may be difficult, as well as cumbersome, to follow directions or look at maps, due to the density of buildings and streets, especially while driving. While conventional navigational tools can get a person from San Diego to Los Angeles to a few blocks or freeway off-ramp in the long haul, the conventional navigational tool is ineffective in the final approach for helping the user pinpoint one out of many buildings, mini-malls, or street corners. The user ends up having to rely entirely on her own physical observation during the final approach. This can become quite dangerous to the driver, and to the rest of people around her.

While GPS has been in use since the Cold War era, the use of GPS based technology still requires the reliance on the GPS satellites and the cooperation from the US Government. Also, a GPS tool necessarily includes a GPS receiver, a GPS transmitter and navigational or mapping software. As such, GPS solutions, while adequate for longer range location tasks, are not as economical for use by the masses.

Other conventional navigational solutions include network-based position determination equipment, which uses cell site network, and real-time locating system, which combines GPS information with cellular network to notify a host system of its location. Due to their involvement of cellular network and carriers, the solutions have not achieved price points appealing to the mass market. Further, they seem to represent a more complicated methodology for a final approach, short range situation.

For example, U.S. Pat. No. 5,055,851, issued to Sheffer, assigned to TrackMobile Inc., discloses a technology for determining a location of a selected vehicle from which an alarm has been generated. Also, U.S. Pat. No. 5,293,645, issued to Sood, assigned to Sharp Microelectronics Technology, discloses a technology for locating mobile and portable phones within a cellular network including several base stations that transmit synchronizing timing reference signals. Further, U.S. Pat. No. 5,479,482, issued to Grimes, assigned to AT&T, discloses technology for a cellular terminal to transmit information defining its location upon placing a 911 call. The teaching of these aforementioned patents is incorporated herein by reference.

Therefore, it is desirable to have a method and system for helping a user locate one or more target destination in a short-range, approaching setting.

It is also desirable to have a method and system for helping a user locate one or more target destination in a short-range, approaching situation without depending on networks.

It is also further desirable to have a method and system for locating a group of target destinations before further narrowing the user's selection in its final approach.

### SUMMARY OF THE INVENTION

A method and system for a local direction finding network is disclosed. The system uses a tracking unit to locate a target location by transmitting signals from the target location to the tracking unit. The tracking unit then verifies the source of the transmission. If matched with the target code entered, the received transmission is used by the tracking unit to determine the bearing and strength, hence navigation information, of the source of the transmission. The tracking unit can then move closer and closer toward the target location based on the navigation information.

Many target locations may be represented by a single transmitter, which will direct the tracking unit to the desired target location, based on the known locations of the transmitter and the target location. Additionally, a networked group of transmitters can be implemented, which, through successive handing off, will direct the tracking unit from one cell to the cell where the target location is located.

### BRIEF DESCRIPTION OF THE DRAWINGS

FIG. 1 illustrates a simplified system diagram of the exemplary embodiment of the present invention.

FIG. 2 illustrates an exemplary flow chart of the operation of a tracking unit in accordance with the present invention.

FIG. 3 illustrates a simplified functional block diagram of an exemplary tracking unit in accordance with the present invention.

FIG. 4 illustrates a simplified system diagram of an exemplary transmitter at a target location in accordance with the present invention.

FIG. 5 is an exemplary code table to identify various entities in accordance with the present invention.

FIG. 6 is a simplified diagram of an exemplary network of transmitter sites.

### DETAILED DESCRIPTION OF THE PREFERRED EMBODIMENT

A method and system for guiding users to one or more target destinations in short-range and approaching setting is disclosed. The method and system in accordance with the present invention, which is tentatively called Location Direction Finding Network (“LDFN”), assists users to locate and track their target destinations, landmarks, buildings and even street blocks, without complicated networks or GPS systems. In the following detailed description, numerous specific details are set forth to provide a full understanding of the present invention. It will be obvious, however, to those ordinarily skilled in the art that the present invention may be practiced without some of these specific details. In other instances, well-known structures and techniques have not been shown in detail so as to avoid unnecessarily obscure the present invention.

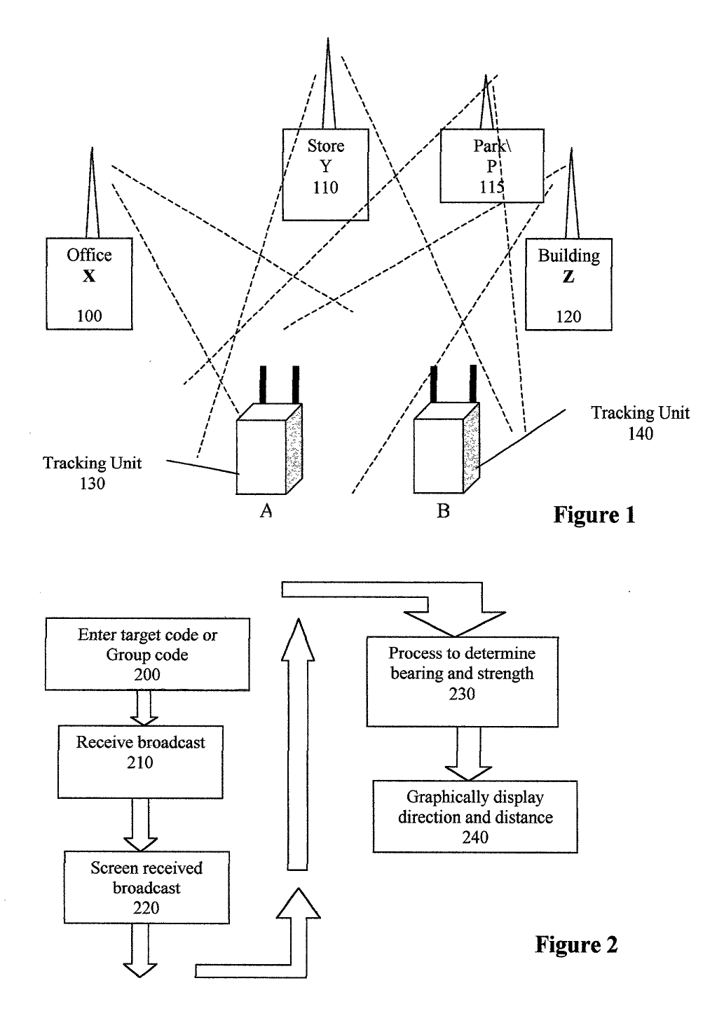

Reference is first to FIG. 1, where a simplified system diagram of the preferred embodiment of the present invention is illustrated. Tracking units A 130 and B 140 are preferably implemented as portable units for users as they make their approaches to within a short range from their destinations. The destinations may be office building X, store Y, park P or building Z. Tracking units A 130 and B 140 in accordance with the present invention can receive transmissions from various transmission sources when they are within the range for reception. While the tracking units receive transmissions from various sources, only one or two sources may be the desired destinations, as entered by the user of the tracking unit.

At each of the potential destinations, a transmitter (“called target unit”) is installed and programmed to modulate and broadcast a uniquely coded signal. The coded signal, when received by a receiver on the tracking unit, can be demodulated and processed to uniquely identify the source. To conserve power, broadcast may occur once every a few seconds. Further, as will be described in connection with FIG. 4, the broadcast can be customized, based on predefined criteria.

As an example, if the user of tracking unit A is looking for office X and has entered a target code unique to office X, tracking unit A 130 is therefore programmed to process only transmission received from the target unit 100 on office X, which matches the entered target code. While tracking unit A may receive many other transmissions from sources within its reception range, those transmissions will have no effect on tracking unit A's directing its user to approach office X.

In accordance with the present invention, tracking units are particularly beneficial in a situation where the user is driving around in a densely-populated area with many look-alike office buildings, strip malls, and commercial developments. After the user enters the target code, e.g. for office X, into tracking unit A, tracking unit A begins to recognize and process only transmission signals from office X. Similarly, tracking unit B 140 may be programmed by its user to recognize and process only transmission signals from the target unit 120 on building Z. By relying on tracking unit's ability to receive and process transmissions from the desired target locations, the users gain the benefit of having a “third eye” to help them reach their destination.

Additionally, instead of locating only one target destination, a user may enter a common group code into tracking unit A 130. The group code may represent a group of offices, banks, or restaurants, just as a few examples. The group code allows the user's tracking unit to receive and process transmissions only from those establishments meeting the group code. For example, all banks may have a group code of “011”, all grocery stores having a group code of “020” and all restaurants having a group code of “030”.

To identify a particular establishment, e.g. Coco's Restaurant, the coding scheme includes a unique code, e.g. 100, to Coco's in Irvine, Calif. Therefore, to look for any restaurants, the user will enter only “030”. To look for Coco's while in the Irvine area, the user will enter “030”, followed by “100”. The coding scheme is preferably coordinated so that each entity or landmark has a unique code, a group code and other descriptive codes such as those that differentiate between an American-style restaurant and a Chinese-style restaurant, between a law firm and a real estate office, or between FedEx and US Post Office. The commercial data base registry company Dunn & Bradstreet may be utilized to standardize the coding scheme. Based on the teaching of the present invention, it should be apparent to those skilled in the art that other schemes of coding can be readily developed based on their application. Nevertheless, it will be preferable to implement a standard set of codes within a region, a state, the whole country or even internationally, such as the European Union.

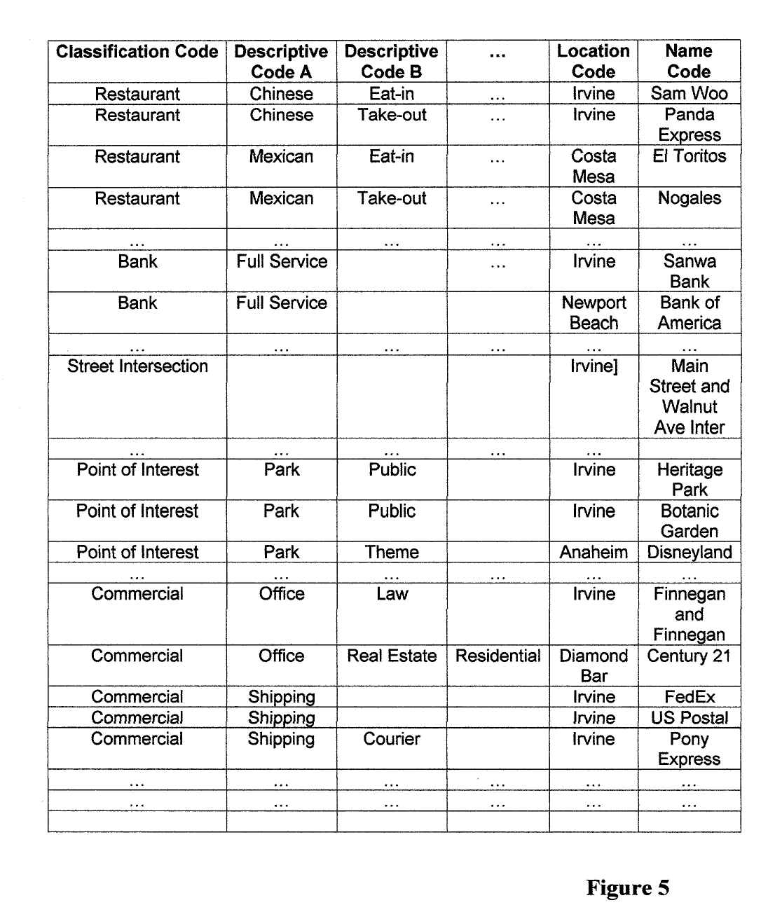

FIG. 5 is an exemplary code table to identify various entities in accordance with the present invention. Each target entity should be assigned at least one unique code, which should comprise at least one of the following: a) at least one classification code, b) at least one specific location code and c) at least one business name code. It should be apparent to those skilled in the art that the entries in the exemplary code table, such as “Restaurant,” or “Park,” are for administrative purposes only. When the codes are actually communicated from the location to the tracking unit, or are verified by the tracking unit, they are represented by electronic signals of zero and one formats. For each kind of entity, there may be more than one descriptive codes implemented to further describe the entity, e.g. classification code, specific location code or business name code. For example, a commercial entity may be a “Law” office, a “Real Estate” office or “Shipping.” Even “Shipping” may be further distinguished between “FedEx” and “Courier.” Additionally, an entity may have multiple target codes, at the same or more refined level, to fully describe its diverse, or alternate, offerings, services, group affiliation, business name, or location.

For example, in addition to the obvious “department or warehouse store,” Wal-Mart may have itself associated with multiple classification codes, or have itself belonging in multiple databases, or lookup tables, such as “auto parts,” “grocery,” “fast food,” “gardening,” “sporting goods,” or “electronics/appliances.” As such, Wal-Mart will not be overlooked by anyone looking for “gardening” tools, instead of “department store.” In other words, a code table may take the form of a simple look-up table, or a more complicated relational database, dependant upon the degree of complexity and functionality.

The target code need not be just assignable to business establishments. The target code can also be assigned to parks, tourist attractions, landmarks, subway stations, streets and street intersections, and even residential locations and homes, provided there is a transmitter nearby such the codes can be broadcast to help locate the target location. In terms of assigning codes to tourist attractions or landmarks, the codes may even distinguish between a public park and a theme park.

Once the codes for target locations are standardized, harmonized and assigned, the codes can be published in the Yellow Pages, on the maps, on the Worldwide Web so that users can easily find the codes for their destinations. For streets and intersections, which are typically not listed in the aforementioned publications other than the maps, the street and intersection codes can be stored in the tracking unit, or downloaded to the tracking unit from an Internet server. Additionally, the tracking unit can be pre-loaded with the generic “Group” codes such as Restaurants, Banks, Hospitals, Police Stations, or Department Store, without the specific name code. Even without the specific code for a target, users can still use the “Group” code to receive signals from any entity with the same group code. If the user knows the specific name code, then, in combination with the “Group” code, the user can use the tracking unit to pinpoint the specific target location.

Further, the tracking units may be pre-loaded on a revenue-generation basis in that those merchants, such as Wal-Mart, Target, or Burger King, can pay to have their codes pre-installed and prioritized into the tracking units. Usually a tracking unit may be only preinstalled with classification group codes. If user selects a group code, he can find all the target locations belonging in this group code. If for example, Wal-Mart pays a pre-loading fee, its name will be shown within the group of “Department Store” on the display. A user can select “Wal-Mart” instead of “Department Store” to narrow and pinpoint the user's search. Differ level pre-loading fees can be implemented to divide by different pre-loading format. Such pre-loading allows the display in a Group setting to be prioritized or highlighted, so as to be distinguishable from other entities. As such, when the user is searching for any department store by entering just a “Group” code, the user will see a highlighted Wal-Mart since its group code makes a link to its specific code is already pre-loaded.

It should be appreciated by those skilled in the art that aspects of the direction finding and homing-in technology using a single frequency are well-known in the art. For example, U.S. patents issued to Apsell et al., assigned to Lo-Jack Corporation, U.S. Pat. Nos. 4,818,998 and 4,908,629, disclose a method and system for tracking stolen vehicles and the like using home-in technology. The teaching of the Apsell patents is hereby incorporated herein by reference as if it is fully set forth herein.

Reference is now back to FIG. 2, where an exemplary flow chart of the operation of a tracking unit 130, 140 is illustrated. The user first enters a code, which may be a group code, or a single target code, to narrow its selection. The tracking unit 130 may begin reception when it is turned on, or it may stay in a sleep, or power save mode, until the user enters a code 200. The tracking unit then begins to receive and filter received broadcast signals 210, 220. Upon receiving signals from sources matching the code 230, the signals' bearing, with or without distance, information are processed and generated. The result is displayed on the tracking unit, in text (“Left”, “Right”), by simple directional arrows or light-emitting diodes, or by more complicated radar-like display. If the code identifies multiple targets, e.g. bookstores, the display of each of the bearing can be done sequentially or concurrently. In a less complicated scenario, where only one target is desired, the display can simply show arrows pointing to the left, right or center. Alternatively, the display may be provided by a circle of light-emitting diodes showing relative bearing of the source of the transmitted signals.

As disclosed by the aforementioned Apsell patents, multiple antennas which are electronically phased to determine the incoming signals by determining the Doppler shift, as is well known, may be used to receive transmission from sources. Multiple antennas are also beneficial in urban settings, where signals tend to bounce off buildings and structures, since the signals coming directly from the source tend to be stronger. If the signal strength appears to be received in erratic mode, the direction of the maximum signal strength can be followed.

It should also be pointed out that a tracking unit may be implemented as an engine, or a sub-system, within a larger electronic system, such as an on-board navigation system of an automobile, or a communication system. Their physical implementation can be achieved with a radio receiving unit, a processing and control unit, and a display unit.

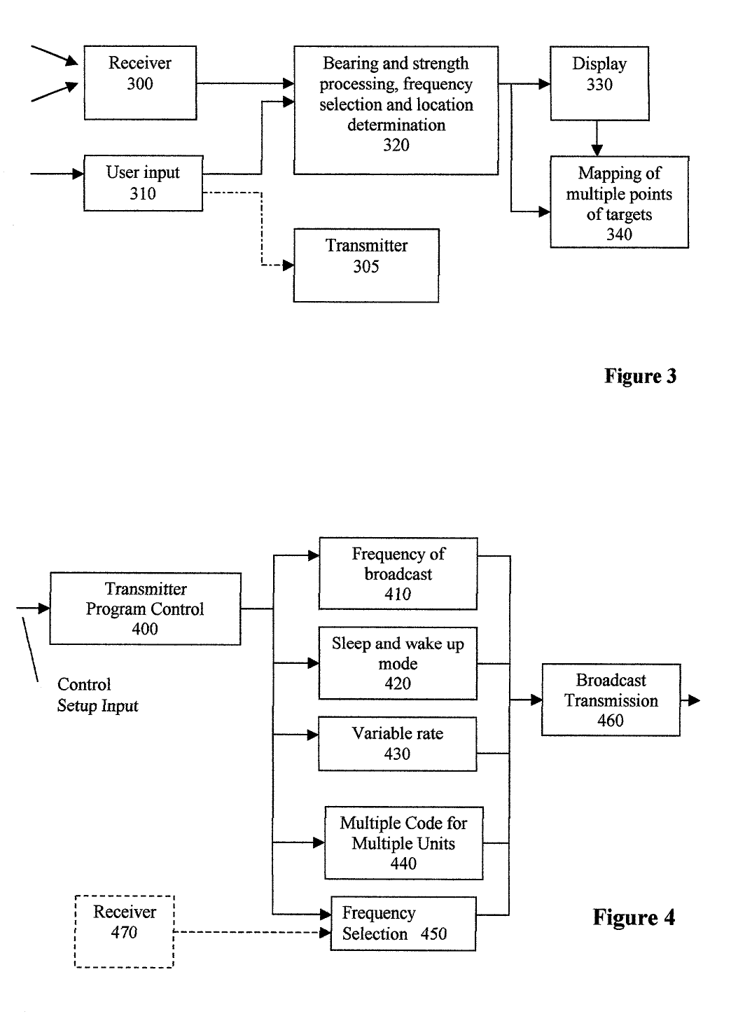

FIG. 3 illustrates a simplified functional block diagram of an exemplary tracking unit in accordance with the present invention. Receiver 300 provides reception of signals, as is well-known in the RF art with antennas. User input 310 allows the user to enter commands and codes of the tracking unit. Receiver processing unit 320 processes the received transmission, tracks the received transmission, and generates bearing and distance information, based on commands and codes entered by user input 310. Display unit 330 then displays the bearing and distance information. Additionally, mapping unit 340 allows the display of the target locations on a radar-like display, as is also well-known, showing multiple target locations. Further, the tracking unit may be provided with a transmitter 305, which sends out signals to target locations to activate transmission, or to negotiate suitable frequency for communication.

FIG. 4 illustrates a simplified system diagram for an exemplary transmitter at a target location. While the primary function of the transmitter is to modulate and broadcast a coded signal, as is well-known, its operation may be implemented with program control 400, which sets up the transmitter at the target location. As can be appreciated by those skilled the art, many types of signal transmission, including one disclosed by the aforementioned Apsell patent, are available for implementing the transmitter of the present invention, provided regulations regarding spectrum, power, and interference, promulgated by governing federals agencies are adhered to. In connection with a memory unit (not shown), program control 400 can specify the following functionality, just to illustrate a few:

Frequency of broadcast 410 specifies the frequency of the transmission. Sleep mode 420 specifies how the transmitter goes into a sleep and power-save mode and how it wakes up upon activation. Variable rate 430 specifies whether the broadcast is done once every 10 seconds, 20 seconds or any interval previously programmed. Also, if there are multiple codes from several targets sharing the same building, multiple code 440 controls how the transmission is switched and alternated. Finally, frequency selection 450 is directed go selecting a better frequency to communicate with the tracking unit, provided several frequency bands have been allocated already.

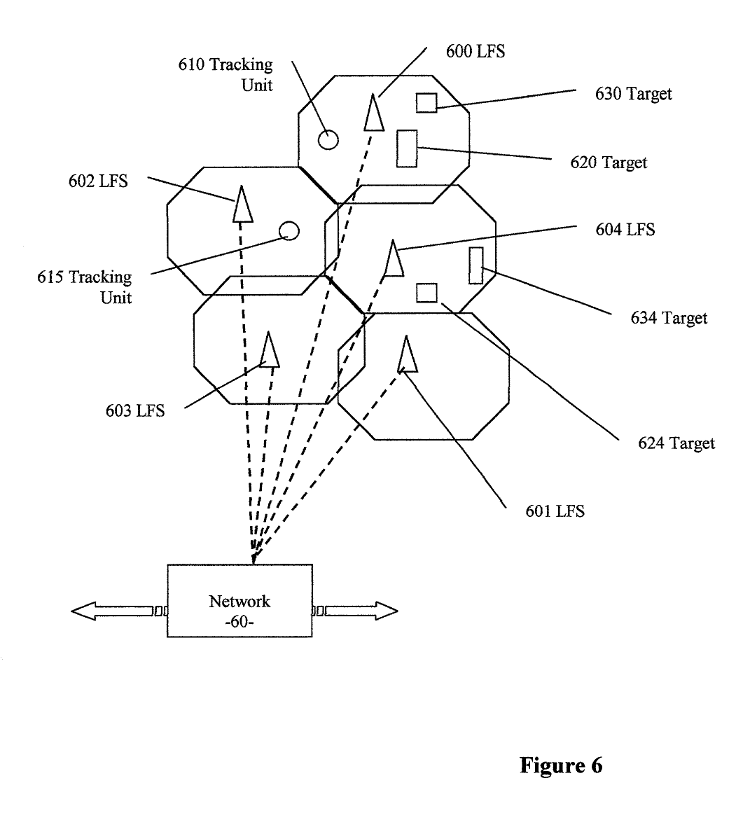

Instead of installing a transmitter tower at each building or at each store front, another aspect of the present invention is directed to having localized transmitter sites to represent and support multiple target entities within each transmitter's neighborhood, or cell. A simplified diagram of an exemplary local fixed signal site (“LFS”) is illustrated in FIG. 6. Within each cell, an LFS is installed. An exemplary LFS 600 can be programmed to store information about the positions, such as latitude/longitude coordinates (“lat/long”), of targets 620, 630 within its cell. As tracking unit 610 moves within cell of LFS 600 to try to locate target 630, it establishes communication with LFS 600. Because LFS 600 is programmed to have the lat/long and/or distance/bearing information of all the fixed target locations , LFS 600 can transmit to tracking unit 610 both the location of LFS 600 itself and the location (in terms of lat/long or distance/bearing) of fixed target 630, which can then triangulate the distance and bearing between itself and fixed target 630. As can be appreciated by those skilled in the art, tracking unit 610 can receive the fat/long positions for LFS 600 and for fixed target 630 from LFS 600 to determine the bearing and direction, all based on the know positions of the two points.

With additional network infrastructure, LFS 600-604 can also be in a networked arrangement. When tracking unit 615 sends a target code to LFS 600, 602, both LFS will search in their database to see if the target is within its cell. The one LFS that has the target within its cell will reply and begin communication with tracking unit 615 to direct it to its target location, while the other LFS is instructed that communication with the requesting tracking unit 615 is already handed off to the other LFS.

It may happen that tracking unit 615 sends a code for target 630 to LFS 602 which does not have the target location within its cell. In this situation, LFS network 60 will assist LFS 602 to find other LFS sites which has the target location 630. Upon determination that another LFS 600 has the target location 630 within its cell, LFS 602 will direct tracking unit 615 toward the cell of LFS 600 to hand off to LFS 600. If there are more cells in-between the tracking unit 615 and its target, then LFS network 60 will coordinate the several LFS sites to go through successive hand-off to direct tracking unit to its destination.

Further, the tracking unit 615 can be adapted to communicate with at least two LFSs, which have known lat/long coordinates. Tracking unit 615 can then easily calculate its present lat/long, based on the known lat/long coordinates of the two LFSs. The tracking unit 615 can then update its own lat/long coordinates by continuously tracking its location relative to the two LFSs based on their known lat/long coordinates.

Therefore, by using conventional method of triangulation based on the fixed locations of LFS locations and the target location, the tracking unit can then be directed to the target location, through successive handing off by the LFS transmitters.

A target location may also be installed at street intersections to allow drivers to find street corners easier than trying to look up street signs, which quite frequently are concealed or not clearly visible to drivers. Such street sites can also be networked so that the driver can be directed to the street comer through successive handing off if the driver begins in a cell that does not have the target street.

Such non-GPS based method of determining the location of mobile units among a fixed array of sites has been well known in industry. For example, U.S. Pat. No. 5,293,645, issued to Sood, is directed to “Apparatus and Method for Locating Mobile and Portable Radio Terminals in a Radio Network.” Also, U.S. Pat. No. 5,963,861, issued to Hanson, is directed to a “Dealer-Locator Service and Apparatus for Mobile Telecommunications System.” U.S. Pat. No. 5,055,851, issued to Sheffer, is directed to “Vehicle Location System.” The disclosure of all of the above patents are hereby incorporated into this application by reference as if fully set forth herein.

In terms of physically implementing the LFS, one of the ways to implement LFS in a network may be to combine an LFS with an existing cell site of a cellular network carrier. Also, the tracking unit be integrated with a cell phone or PDA, as previously mentioned.

The locating and tracking system of the present invention can be quite useful in a setting such as a shopping mall, an amusement park or a closely populated urban district. In a shopping mall setting, each store can have its own transmitter for the shopper's a tracking unit to locate the store. For example, a shopper may be directed to a COACH® store by entering its appropriate code upon entering the shopping mall. Then the shopper will simply let the tracking unit to do guiding for her. More practically, a shopper may enter a code to be directed to the nearest restroom or ATM machine. As anyone who has tried to locate a non-anchor store, i.e. not the likes of Macy's®, Sears®, or Nordstrom®, in a mall can appreciate, the conventional 2-dimentional map display of “YOU ARE HERE” provided by the mall management can be quite confusing. Such 2-dimensional display of a complex multi-level shopping mall can end up not being very helpful to shoppers. This undesirability associated with the conventional map display is not surprising, since the conventional 2-D map layout tells you exactly where the shopper is, and only that; the “static” display cannot dynamically direct the shopper to the desired destination. With the tracking unit and the system of equipping every store front with a transmitter, the shopper can simply let the tracking unit guide the shopper where to go.

The locating and tracking system of the present invention is even more useful in an amusement park setting, which has a much more complicated layout for its rides, attractions, food stands, restaurants, restrooms, and photo spots. If the rides, attractions, food stands, restaurants, restroom and photo spots are equipped with a transmitter, a visitor can use the portable tracking unit to find the desired location easily, without having to constantly confirm with a map. Additionally, the tracking unit may be equipped with a routing tool to provide route assistance and optimization, if the user enters several desired locations into the tracking unit. The desired locations may include all the rides that are children-friendly or thrilling, depending on the user's preference. Such preference setting can then be entered into the tracking unit, which will plan and direct the user to the desired locations.

Further, the transmitter may be equipped to transmit additional information, such as the length of the wait at the attraction, or the next show time, for the tracking unit to receive, and to optimize its route planning. In the mall setting, information regarding the store, e.g. promotional sales or deals, can also be sent to the tracking unit. This way, the shopper not only gets the real-time direction to the store, but also gets the real-time promotional information.

Further extension of the present invention can be applied to the deployment of every physical location in a large regional network. Any physical location or landmark can be represented or supported by a code, which is broadcast by transmitters. The tracking unit can be integrated or cooperate with the cell phone or PDA to find any fixed or moving target close, but not visible, to the users. The present invention thus extends the physical vision of the users to help users find their destinations quicker and easier.

Other well-known circuits and apparatus and conventionally derived software for performing the stated functions than those shown may also be used, as may certain functions be omitted if not desired. Also, while specified features of the invention may be shown in some drawings and not others, this is for convenience and clarity of description only, it being understood that each feature may be combined with any or all of the other features of the invention. Similarly the particular selection of types of tracking, communication and broadcasting antennas, etc., are illustrative of what is believed to be preferred; but further modifications will occur to those skilled in this art, and such are considered to fall within the spirit and scope of the invention as defined in the appended claims.

I claim:

1. A method of directing a mobile user with a tracking unit to at least one of a plurality of fixed target units in a predetermined region, each of said fixed target units being installed to represent at least one target entity, each of said fixed target units being adapted to broadcast a predetermined signal representative of said at least one target entity, the method comprising:
a. assigning at least one target code to each of said plurality of fixed target units to represent at least one target entity for broadcasting by each fixed target unit;
b. entering at least one target code to said tracking unit as said mobile user's destination;
c. receiving at least one broadcast signal from at least one of said plurality of fixed target units using said tracking unit;
d. verifying said at least one broadcast signal using said target code and said tracking unit;
e. if said broadcast signal matches said target code, determining at least navigation information of said fixed target unit using said tracking unit;
f. displaying said navigation information using said tracking unit:

2. The method of claim 1, and
in which said navigation information comprises bearing information.

3. The method of claim 2, in which said fixed target unit is adapted to vary its frequency of transmission based on predetermined criteria;
in which said tracking unit is adapted to broadcast a wake-up signal, and
in which said fixed target unit, upon receiving said wake-up signal, is adapted to broadcast said predetermined signal.

4. The method of claim 3, and in which said fixed target unit is adapted to transmit a signal carrying a plurality of codes, each code being representative of a predetermined target entity.

5. The method of claim 1, and in which said tracking unit is installed with mapping software and said tracking unit is adapted to graphically display the location of said target location relative to said tracking unit using said mapping software.

6. The method of claim 1, and in which said tracking unit is adapted to receive a plurality of signals from said plurality of fixed target units, each of said signals corresponding to said target code entered by said user.

7. The method of claim 1, and in which said tracking unit is adapted to receive a plurality of signals from a plurality of fixed target units, corresponding to a plurality of target codes entered into said tracking unit.

8. The method of claim 1, and in which said tracking unit is adapted to graphically display said plurality of fixed target units.

9. The method of claim 1, and in which said tracking unit and said fixed target units jointly determine a better frequency to communicate.

10. The method of claim 1, further comprising:
a. entering a group code to said tracking unit, said group code being representative of a predetermined group of fixed target units;
b. receiving a plurality of broadcast signals from said fixed target unit using said tracking unit;
c. verifying identity of each of said plurality of broadcast signals using said group code and said tracking unit;
d. if said signals match said group code, determining a bearing information for each of said predetermined group of target entities using said tracking unit;
e. displaying said bearing information for each of said group of target entities.

11. The method of claim 10, further comprising the step of:
entering a second code, representative of one target entity within said predetermined group of target entities;
displaying said bearing information for said target entity.

12. A system for directing a user to locate at least one target entity from a plurality of target entities, comprising:
a plurality of target units adapted to represent said plurality of target entities, each of said target units comprising:
a broadcast unit adapted to broadcast a target signal representative of a predetermined group of target entities;
at least one tracking unit, said tracking unit comprising:
a data entry unit adapted to enter at least one target code entered by said user;
a receiver unit adapted to receive at least one target signal from at least one target unit and to determine if said target signal matches said target code entered;
a direction-finding unit adapted to determine bearing of said target signal if said target signal matches said target code;
a display unit adapted to display the bearing of said target entity.

13. The system of claim 12, wherein:
said target unit further comprises:
a receiver unit adapted to receive a wake-up signal, said wake-up signal activating said target unit;
said tracking unit further comprises:
a transmitter unit adapted to transmit a wake-up signal to said target unit.

14. The system of claim 12, wherein:
said data entry unit for said tracking unit is adapted to receive a plurality of target codes from said user;
said receiver unit for said tracking unit is adapted to enter a plurality of target signals from a plurality of target units, and determines whether said plurality of target signals match any of said plurality of pre-loaded target codes;
said direction-finding unit is adapted to determine bearings of target signals matching said target codes;
said display unit is adapted to display all bearings of said plurality of target units.

15. The system of claim 12, wherein said tracking unit and said target unit jointly determine a more appropriate frequency for communication based predetermined quality criteria.

16. The system of claim 12, wherein each of said target units is adapted to support a plurality of target entities within a predetermined range.

17. The system of claim 16, wherein said broadcast unit is adapted to broadcast a target signal comprising a plurality strings of descriptive codes, each of said strings identifying at least one of a plurality of target entities supported by said target units.

18. The system of claim 17, wherein:
said direction-finding unit is adapted to determine one of bearing with distance and bearing without distance of a plurality of target signals;
said display unit is adapted to display said one of bearing with distance and
bearing without distance of said plurality of target units.

19. The method of claim 1, wherein said tracking units is pre-loaded with a plurality of classification codes and specific target codes, wherein every entity belongs to at least one of said classification codes, wherein said specific target codes are assigned based on a set of predetermined criteria.

20. The method of claim 19, wherein said set of predetermined criteria comprises payment of fees.

21. The method of claim 1, wherein said broadcast signals of said target unit combines target code with live messages, said live messages adapted to be displayed by said tracking unit to show information provided by said target entity.

22. The method of claim 1, wherein said at least one broadcast signals comprise information from said plurality of target entities.

23. The method of claim 1, wherein said step of displaying comprises at least one of the following:
a. displaying of routing to said target location using north, south, west and east pointers;
b. displaying of a destination spot relative to the present location;
c. displaying of turning direction;
d. displaying of distance to destination by varying color, intensity, size or numbers.

24. The method of claim 12, wherein said at least one broadcast signal comprises data massages corresponding to said target entities.

25. A system for a direction finding network for a plurality of target locations within a predetermined geographic region, comprising:
a plurality of target transmitters, each of said plurality of target transmitter being adapted to broadcast a guiding signal comprising location information of at least one of said target locations and of said target transmitter;
a plurality of tracking unit, each tracking unit comprising:
a data entry unit adapted to enter a target code entered by a user;
a receiver unit adapted to receive said guiding signals from said target transmitters and to determine if one of said plurality of guiding signals matches said target code;
a direction-finding unit adapted to determine bearing information of a target location, upon a match between said target code and one of said guiding signals, based on location information of said target location and of said transmitter;
a display unit adapted to graphically display the bearing of said target location.

26. The method of claim 1, wherein said target code comprises at least one of the following:
at least one classification code;
at least one descriptive code;
at least one specific location code;
at least one business name code.

27. The system of claim 25, wherein at least one of said transmitters is deployed (hereinafter “LFS”) to represent a plurality of target locations, wherein said LFS is programmed to store information about the positions of its represented target locations and to send multiple signals to represent all those target locations, wherein when said tracking unit searches any one of these target locations, said tracking unit communicates with said LFS to use the latitude and longitude information for both said LFS and target location to triangulate the bearing and distance between said tracking unit and the target location.

28. The system of claim 27, wherein a plurality of LFS's are installed and networked together to represent a plurality of cell regions, wherein said tracking unit is directed to a target location which is not in a first cell region by using hand-off by one a first LFS to a second LFS from a first cell region to a second cell region, such that said tracking unit. uses said networked LFS's to navigate all location where this networked LFS is deployed.

29. The system of claim 12, wherein at least one of said target signals combines a target code with live messages, said live messages adapted to be displayed by said tracking unit to show information provided by a target entity associated with said target code.
